(19) United States
(12) Patent Application Publication
(10) Pub. No.: US 2026/0182750 A1
(43) Pub. Date: Jul. 2, 2026

(54) A THERMOPLASTIC ELASTOMERS (TPE) CHANGING MAT

(71) Applicants: Niels Peter ESTRUP, Grundfør, Hinnerup (DK); PAPA’S GOT A BRAND NEW TAG, Grundfør, Hinnerup (DK)

(72) Inventor: Niels Peter ESTRUP, Grundfør, Hinnerup (DK)

(21) Appl. No.: 19/130,269

(22) PCT Filed: Nov. 16, 2023
(86) PCT No.: PCT/DK2023/050278

§ 371 Date: May 15, 2025

(30) Foreign Application Priority Data
Nov. 17, 2022 (DK) PA202201058

(51) Int. Cl. A47D 5/00; A47D 15/00; C08L 53/00

(52) U.S. Cl. CPC A47D 5/006; A47D 15/005; C08L 53/00; C08L 2203/14; C08L 2207/04

(57) ABSTRACT

A changing mat for a baby made of foamed and/unfoamed thermoplastic elastomers based on styrenic-blockcopolymers (TPS). The mat is flexible and has folding lines—such that the mat can be rolled—, has integrated lighting, and straps/belts for fastening the mat to a surface. The mat is injection molded from TPS thus achieving a one-piece changing mat. The TPS can be made of renewable biomaterials or be 100% upcycled to new changing mats after use.

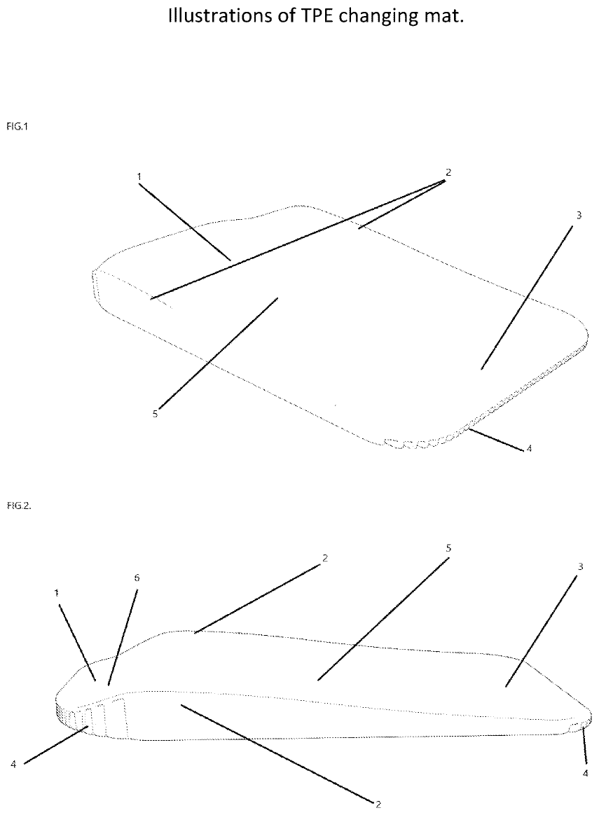

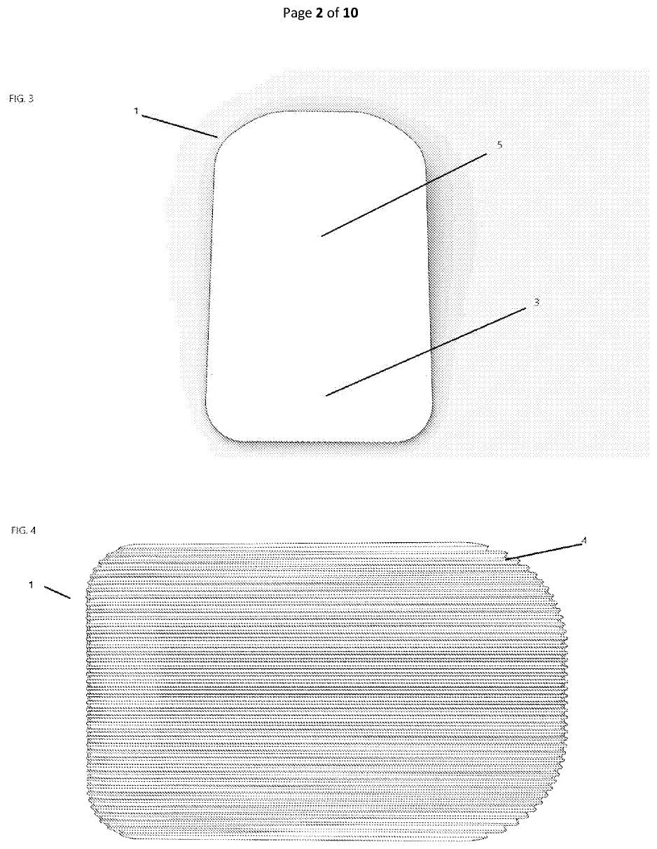

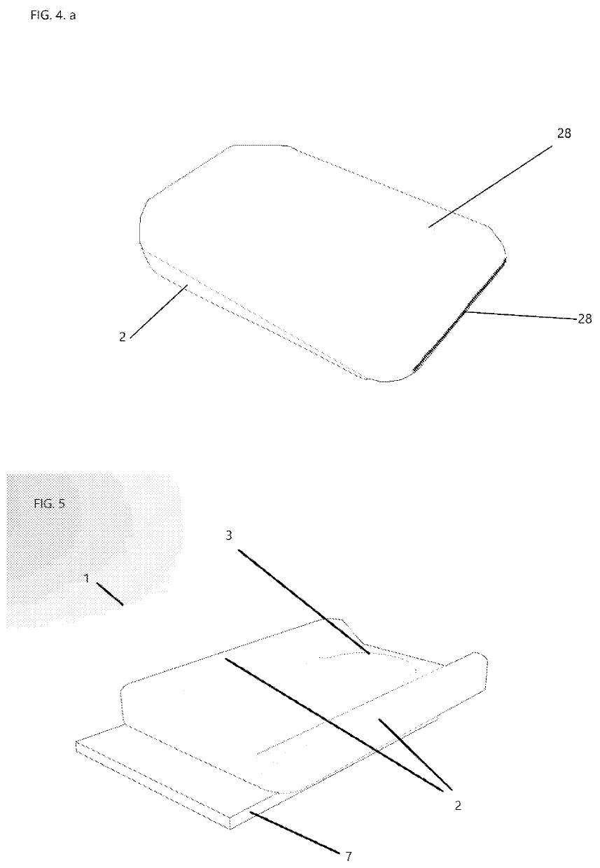

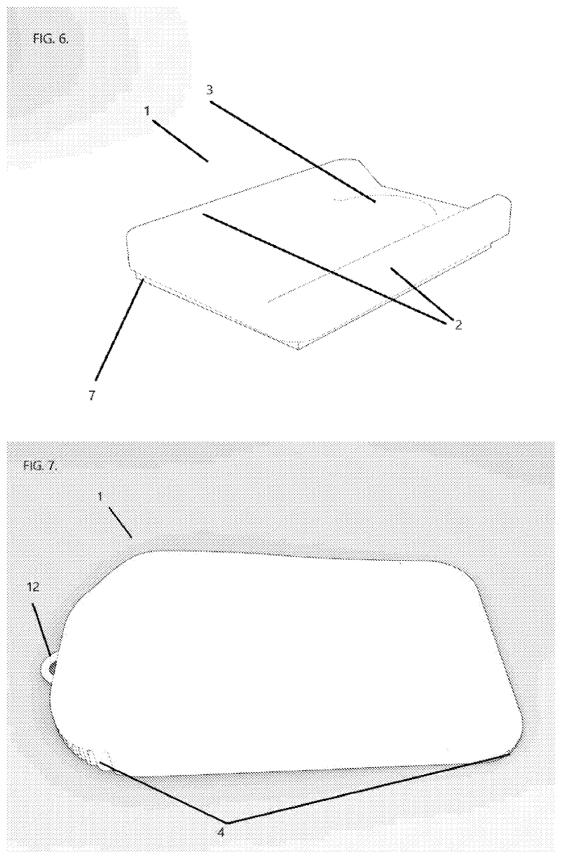

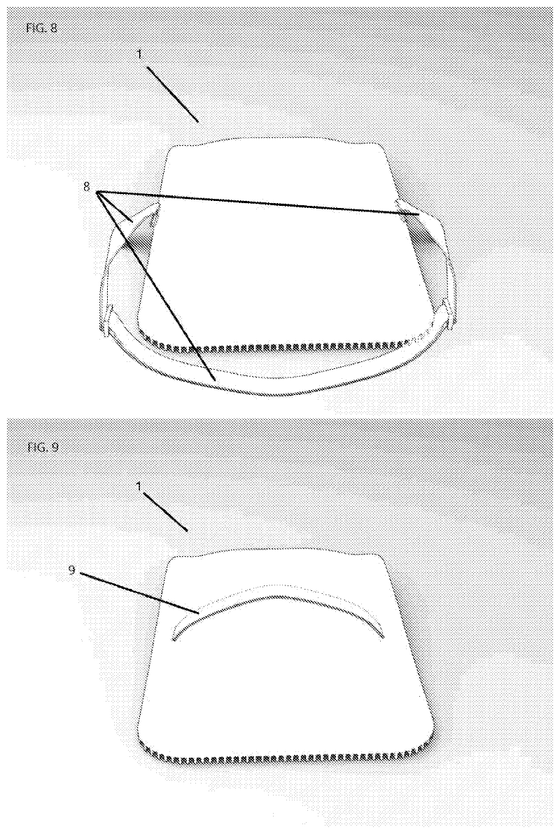

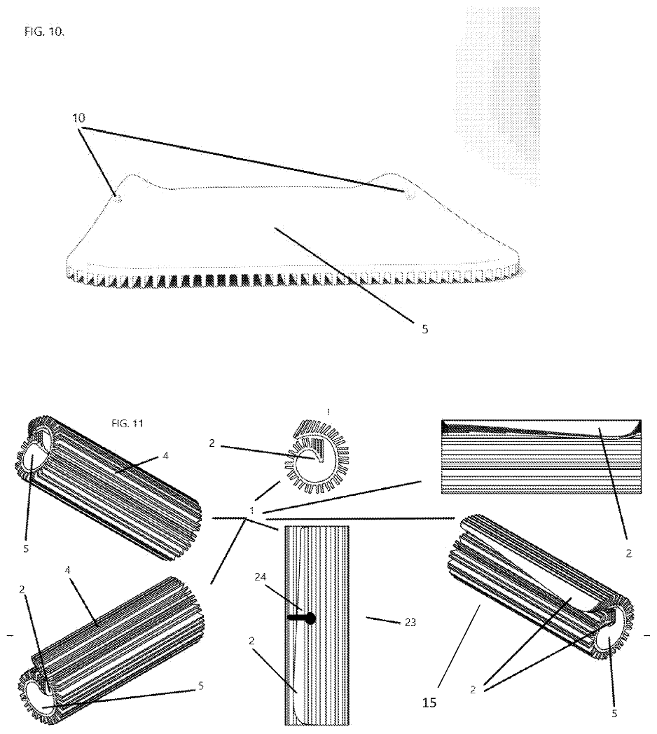

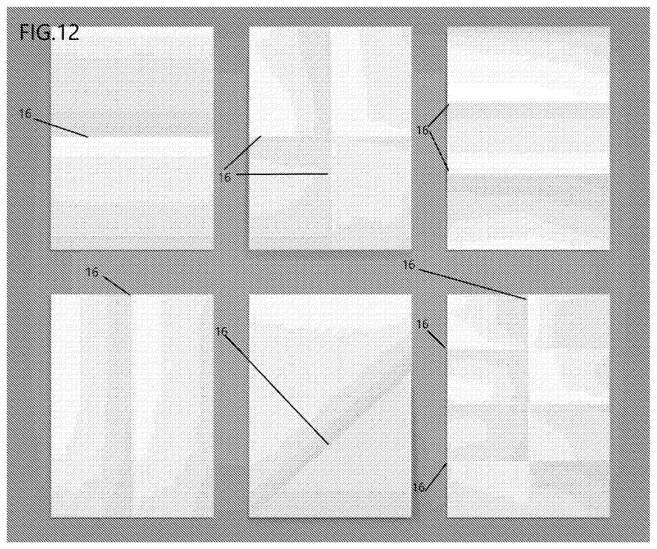

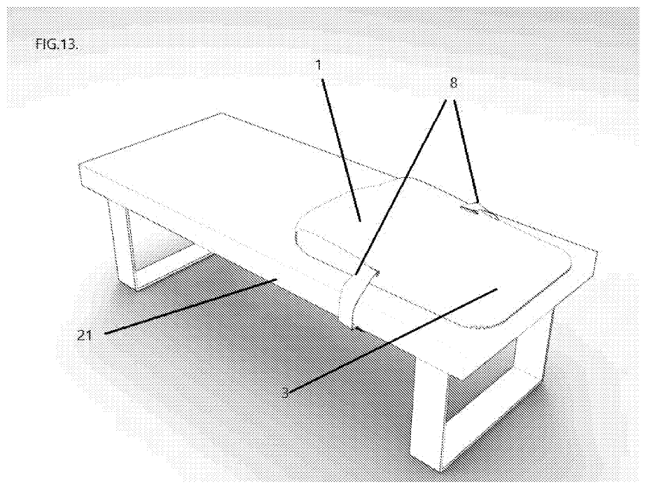

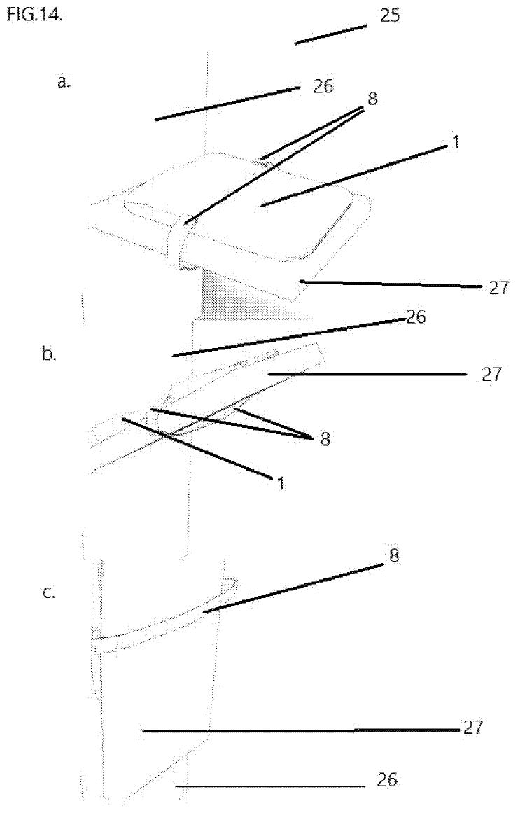

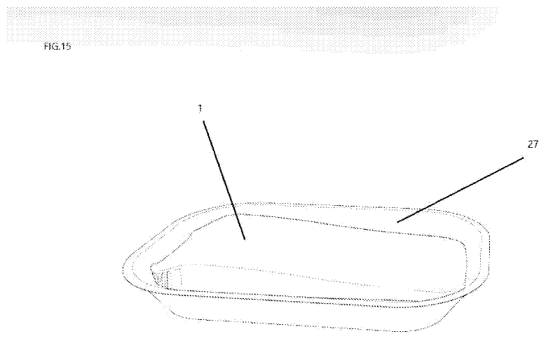

The present invention relates to a Changing mat/pad (1), comprising an area (5) where a parent will have excellent workability and enabling the easy changing of the baby's diaper.

The TPE Changing mat (1) is provided with two barriers left and right (2) to prevent the child to roll out. TPE Changing mat (1) is made of flexible TPS (thermoplastic elastomers based on Styrenic-block-copolymers) material. The TPE Changing mat (1) have a top (6) (head) and a bottom side (3) (feet), the feet area (3) is lower placed than the head-end by a low angle from the head piece (6) to the foot end (3), which allows liquid to flow down to foot-end (3), at the bottom of the mat (1), this makes it easily to wipe away the liquid (urine). The Changing mat) 1) have a surface (5) for the baby to lie on and here the change of the diaper can take place without getting all surroundings dirty or wet and the baby will feel comfortable sine the material is soft and the mat will be very close to a skin sensation, not too cold or too warm and the back of the changing mat can have folding lines all depends on the mat solution, flexible or rigid.

The flexible TPE Changing mat (1) is made in TPS material since this material is 100% recyclable, normally a changing mat will be made in some kind of a foam to make the material softer and smoother to lie on and this TPE mat (1) can also be made in TPE foam, which have the same good properties as silicone, latex, rubber and polyurethane foam. The TPE foam can be made in bio-based granulate which is not possible in the usually conventional Changing mats material that typically is made of latex, rubber, polyurethane, or silicone. This Thermoplastic elastomer based on Styrenic-block-copolymers is not made with rubber, latex, polyurethane or silicone and it is 100% recyclable.

This TPE Changing mat (1) will typically be made in a one-piece material and in TPE foam but can also be injected molded onto a rigid material (7) to make it hard and non-flexible too. The TPS changing mat (1) also offers light (10) integrated into the mat, this provides light in the area where you typically change the nappy and it is practical especially at night when you don't want to turn on too much light, thereby waking the child and everyone in the room, it is practical that you don't have to use effort and a hand to turn on the light, the automatic sensor light in the mat will automatically turn on when the baby is placed on the mat surface (5).

The foldable and flexible TPE foam makes the changing mat (1) easy to bring, when traveling with a baby and the material will make the changing mat (1) non-slip and easy to fit on to must surfaces and places (21, 25). The integrated light (10) will make it possible to change the baby's diaper even without turning the main light on and you all so have light if the mat is brought to another place/traveling.

The material is very light and very adaptable to the room temperature and will provide a skin-like sensation when the baby touches the TPE foam mat (1). This TPE foam also makes the cleaning operation of the changing mat (1) very easy, the foam can withstand most cleaning agents and can easily be desensitized with ethanol and other normal cleaning agents.

This TPE Foam Changing mat (1) material still retain all the good properties that are important for changing mats, but one thing that really sets this mat apart is reusability.

A patent US 2018/0055246, shows a changing mat, the material used for making the changing mat in US 2018/0055246 is not recyclable. They mention EVA foam and EVA foam made of vinyl cannot be recycled, elastomeric polymers, have the same issue and if made of foam again nothing is recyclable. They also mention polypropylene (PP) if made of this material the mat will be hard and not flexible. Our invention The TPE changing mat is made of TPS (thermoplastic elastomers based on Styrenic-block-copolymers) material, and this material is soft and you can regulate how soft you want the material to be and it is 100% recyclable. US 2018/0055246 is also pointing out a night light in their changing mat in 0039.

Again we claim that our TPE changing mat have integrated light in the mat, we use a on/off sensor and the US 2018/0055246 mention a weight or load sensor—again very different from our invention since we don't have to place the child on the mat to turn on the light—we uses sensors not weight sensors.

TPE foam is 100% recyclable and there is no formaldehyde inside the TPE foam material since it is not vulcanized like silicone and rubber/latex.

However, some changing mats are made of different kind of foam, most of these mats are made of more than one kind of material and some mats are made of polyurethane foam entirely, the TPE foam changing mat is made of Thermoplastic elastomer based on Styrenic-block-copolymers (TPS).

Changing mats are in generations made of different foams or textiles, wood and/or with silicone or latex/rubber. Some changing mats are even made of two kinds of materials molded together like an over-molding process, then it appears as a one-piece changing mat and typically impossible to disassemble for recycling purposes.

The TPS foam changing mat (1) is made in one process and with one material and/or in several parts flexible and/or in rigid parts being, injected molded. The difference between this TPS changing mat (1) and already known changing mats is the production and material used with or without over-mold, and/or co-mold where there's is a rigid center underneath the TPS, this invention TPE changing mat (1) is made of solid TPS or/and together with a rigid part inside the TPE foam.

The TPS changing mat can be made in a one-piece tool or in a way where the back (7) is molded on its own in one material and then assembled to the top surface (5) foam afterwards.

This TPE changing mat is made in flexible and/or rigid TPS (Thermo plastic elastomers based on Styrenic-block-copolymers) due it is known as a safe, material and without any harmful components and it is available in renewable granulate. The key factor of this TPE changing mat made in one or in several parts flexible and/or in rigid parts being, is that it can recycled and be injected molded with green materials said leftovers from the sugar plant, corn production and this material is 100% recyclable and then again, the used changing mats can be shredded into granulates and again be reused into new changing mats, then a closed loop of changing mats are made.

TPE foam is a very strong, and it has a closed fiber construction compared to polyurethane, the durable TPE foam material thermoplastic elastomers based on Styrenic-block-copolymers will keep dry and easy to clean. Compared to the known changing mats made of rubber, polyurethane or silicone, TPE material shows it is very resistant to oils, food and many different chemicals and the material withstands frost and boiling, as well as sun rays (UV). Compared to other foams normally used for this kind of mats, the thermoplastic elastomers based on Styrenic-block-copolymers is 100% recyclable and can be made of renewable materials.

The TPS changing mat is easy to clean and keep clean.

Everyday thousands of changing mats are thrown out, burned of the simple reason that they cannot be recycled.

A new family typically wants a new changing mat since it is a private matter and a germ-filled matter of changing one's baby, so people don't buy secondhand mats like they buy a secondhand bike.

Therefore, this new material for changing mats is extremely important and suitable, as it solves the task of changing the child, but at the same time the TPS material can withstand the situations the mats are normally exposed to, in fact better or alike than both rubber, polyurethane and silicone, in most situations, but the most important thing is the recycle possibility. TPS is harmless and safe without phthalates, and it can even be produced in bio material which is an environmentally conscious solution, but the fact that the TPS can be recycled 100% must be one of the most important parameters, to bring this new invention out into the world.

This TPS changing mat also provides light into the mat—these sensor lights will be easy to disassemble when going to reuse the TPS material and the light-panel can also be reused.

1. A thermoplastic elastomers (TPE) changing mat (1), for a baby, which mat (1) is in one or several injection molded flexible and/or rigid parts variating in thickness and comprising an upper lying surface (5) with barriers (2), a liquid collect area and foot-end (3), the foot-end (3) as the thinnest part and the barrier (2) thicker than the lying-surface (5), thereby the mat (1) being angled for liquid applied on the lying-surface (5) to run to the foot-end (3) of the mat (1) which mat (1) is flexible to be foldable (16) and/or made with a rigid back plate (7) allowing the mat (1) to be placed on uneven surfaces, characterized in, that the mat (1) is made entirely of foamed and/unfoamed thermoplastic elastomers based on styrenic-block-copolymers (TPS).

2. The TPE changing mat (1) according claim 1 has a grip (12), for easy handling, when moving/lifting the TPE changing mat (1).

3. The TPE Changing mat (1) according to claim 1, will have folding lamellas (4) or folding pattern under the lying surface (5) of the mat (1).

4. The TPE Changing mat (1) according to claim 1, made in a flexible TPS with or without folding lines (16) such that the mat can be rolled into a tube (23) and the tube (23) can have a locking device (24) attached to prevent the tube (23) to unfold, when the mat (1) is folded.

5. The TPE changing mat (1) according claim 1 can also be made to fit into a frame (27) around the TPE changing mat (1), the frame (27) will be made of a rigid material.

6. The TPE changing mat (1) according claim 1, the mat (1) has thinner folding (16) lines, making the TPE material fold in wanted positions (16, 23).

7. A TPE changing mat (1) according claim 1, where the mat can have an integrated light (10)-, with an on and off sensor, battery or solar powered.

8. A TPE changing mat (1) according claim 1 has belts/straps (8, 9) attached to the sides (2), configured to fasten the mat (1) to a surface/table (21) or when placed in a standing frame/table (21) or a wall hanged changing station (25) to ensure the TPE mat (1) stays in the same position when closing a wall hanging device (c) or prevent the mat (1) from falling down when it is in use, the straps (8, 9) are also configured to prevent the baby from rolling out of the mat (1) over barriers (2).

9. The TPE changing mat (1) according claim 1 made of renewable TPS (Thermoplastic elastomers based on Styrenic-block-copolymers).
